(19) United States
(12) Patent Application Publication
(10) Pub. No.: US 2024/0286924 A1
(43) Pub. Date: Aug. 29, 2024

(54) POSITIVE ELECTRODE COMPOSITE MATERIAL, PREPARATION METHOD THEREOF, POSITIVE ELECTRODE AND LITHIUM ION SECONDARY BATTERY

(71) Applicant: MURATA MANUFACTURING CO., LTD., Kyoto (JP)

(72) Inventors: Jixian LV, Shanghai (CN); Siming YANG, Shanghai (CN); Yuli LI, Shanghai (CN); Kazumasa TAKESHI, Shanghai (CN)

(21) Appl. No.: 18/585,430

(22) Filed: Feb. 23, 2024

(30) Foreign Application Priority Data
Feb. 28, 2023 (CN) 202310214441.0

(51) Int. Cl. C01G 53/00; H01M 4/02; H01M 4/36; H01M 4/505; H01M 4/525; H01M 10/0525

(52) U.S. Cl. CPC C01G 53/50; H01M 4/364; H01M 4/505; H01M 4/525; H01M 10/0525; C01P 2002/08; C01P 2002/85; C01P 2004/03; C01P 2006/40; H01M 2004/028

(57) ABSTRACT

The present invention provides a positive electrode composite material, a preparation method thereof, a positive electrode and a lithium ion secondary battery. The positive electrode composite material comprises: a positive electrode matrix material doped with Mg element; and a fluoride present on the surface of the positive electrode matrix material in a dotted form, the fluoride containing MgF₂. By the positive electrode composite material, the method for preparing the positive electrode composite material, and the positive electrode and the lithium ion secondary battery which contain the positive electrode composite material in the present invention, the positive electrode matrix material in the lithium ion secondary battery can be effectively prevented from being corroded by an electrolyte, and more lithium ion channels can be reserved, thereby improving the cycle performance of the lithium ion secondary battery, and reducing the impedance increase of the lithium ion secondary battery while not affecting the capacity and initial impedance of the lithium ion secondary battery.

### CROSS REFERENCE TO RELATED APPLICATIONS

The present application claims a priority to Chinese patent application no. 202310214441.0, filed on Feb. 28, 2023, the entire contents of which are incorporated herein by reference.

### TECHNICAL FIELD

The present invention relates to the field of lithium ion secondary batteries, and in particular, to a positive electrode composite material, a method for preparing the positive electrode composite material, and a positive electrode and a lithium ion secondary battery which contain the positive electrode composite material.

### BACKGROUND

In recent years, along with the continuous development of electronic technology, demand of people for a battery apparatus supporting energy supply of an electronic device is also increasing continuously. Today, batteries capable of storing more electric quantity and capable of outputting high power are needed. Conventional lead-acid batteries and nickel-hydrogen batteries, etc. have been unable to meet the requirements of new electronic products such as mobile devices such as smart phones and fixed devices such as electric power storage systems etc. . . . Therefore, lithium ion batteries have attracted people's wide attention. In the development of lithium ion batteries, the capacity and performance thereof have been improved effectively.

A lithium ion secondary battery comprises a positive electrode containing a positive electrode material, a negative electrode, and an electrolyte. The configuration of the positive electrode material has a large effect on the performance of the lithium ion secondary battery. Various studies have been carried out regarding the configuration of the positive electrode material. The prior art discloses that a positive electrode precursor is treated to cover one or more substances of Co₂O₃, B₂O₃, Al₂O₃ and Al(OH)₃ on the surface of a matrix; however, this method may increase the initial electrochemical reaction impedance of a material, and a high temperature required for the covering causes high energy consumption. The prior art further discloses coating LiNi_{0.8}Co_{0.1}Mn_{0.1}O₂ with a pyrophosphate having a chemical composition MₓP₂O₇, where M is one or a combination of more of Ti, Na, K, Cu, Mg, Al, Zn and Ca; however, the coating obtained by this method has poor electron conduction and ionic conduction performance, causing increased impedance of the positive electrode material, thereby reducing the rate capability.

The positive electrode material in the prior art cannot effectively improve the cycle and ameliorate the impedance increase of the lithium ion secondary battery. Therefore, it is necessary to develop a novel positive electrode composite material, a method for preparing the positive electrode composite material, and a positive electrode and a lithium ion secondary battery which contain the positive electrode composite material.

### SUMMARY

A main object of the present invention is to provide a positive electrode composite material, a method for preparing the positive electrode composite material, and a positive electrode and a lithium ion secondary battery which contain the positive electrode composite material, so as to solve the problems of the positive electrode material in the prior art that it is difficult to effectively improve the cycle and ameliorate the impedance increase of the lithium ion secondary battery.

In order to achieve the object, according to one aspect of the present invention, provided is a positive electrode composite material, the positive electrode composite material comprising: a positive electrode matrix material doped with Mg element; and a fluoride present on the surface of the positive electrode matrix material in a dotted form, the fluoride containing MgF₂.

Further, in the positive electrode composite material, the fluoride also contains one or more of LiF, AlF₃, NH₄F, MnF₄, TiF₃, ZrF₄, SrF₃ and MoF₅.

Further, in the positive electrode composite material, based on the weight of the positive electrode matrix material, the doping concentration of the Mg element is in the range of about 0.05 wt % to about 4.00 wt %, preferably in the range of about 0.30 wt % to about 1.00 wt %.

Further, in the positive electrode composite material, the amount of fluorine element in the positive electrode composite material is in the range of about 0.03 wt % to about 0.60 wt %, preferably in the range of about 0.06 wt % to about 0.30 wt %.

Further, in the positive electrode composite material, the positive electrode matrix material contains a high-nickel positive electrode material of general formula LiNiₓCo_{y}M_{(1-x-y)}O₂, where M is selected from one or two of Al and Mn, x≥0.6, and 0<y<0.4.

Further, in the positive electrode composite material, the Mg element is distributed in a gradient manner within particles of the positive electrode matrix material, and the concentration of the Mg element gradually decreases from the inside of the particles toward the outside of the particles.

According to another aspect of the present invention, provided is a method for preparing a positive electrode composite material, the method comprising: step S1: mixing a positive electrode material precursor, lithium hydroxide and magnesium oxide to obtain a first mixture, and then sintering the first mixture at a first temperature for a first time to obtain a sintered product; and step S2: mixing fluoride with the sintered product to obtain a second mixture, and then calcining the second mixture at a second temperature for a second time.

Further, in the method for preparing a positive electrode composite material, in the step S1, the first temperature is within a range of about 650° C. to about 780° C., and the first time is within a range of about 6 h to about 24 h.

Further, in the method for preparing a positive electrode composite material, in the step S2, the second temperature is within a range of about 200° C. to about 350° C., and the second time is within a range of about 2 h to about 8 h.

Further, in the method for preparing a positive electrode composite material, the fluoride contains one or more of MgF₂, LiF, AlF₃, NH₄F, MnF₄, TiF₃, ZrF₄, SrF₃ and MoF₅.

Further, in the method for preparing a positive electrode composite material, based on the weight of the positive electrode material precursor, the amount of the magnesium oxide is in the range of about 0.10 wt % to about 5.00 wt %, preferably in the range of about 0.50 wt % to about 1.50 wt %.

Further, in the method for preparing a positive electrode composite material, based on the weight of the positive electrode material precursor, the amount of the fluoride is in the range of about 0.05 wt % to about 1.00 wt %, preferably in the range of about 0.10 wt % to about 0.50 wt %.

Further, in the method for preparing a positive electrode composite material, the sintering or the calcining is performed in an air atmosphere or an oxygen atmosphere.

Further, in the method for preparing a positive electrode composite material, in the step S2, mixing of the fluoride and the sintered product is carried out in a ball mill for about 10 min to about 60 min, and the rotational speed of the ball mill is in the range of about 250 r/min to about 300 r/min.

Further, in the method for preparing a positive electrode composite material, the positive electrode material precursor contains a material of general formula NiₓCo_{y}Mn_{(1-x-y)}(OH)₂ or NiₓCo_{y}Al_{(1-x-y)}(OH)_{(3-x-y)}, where 0.8≤x<1 and 0.01≤y<0.2.

Further, in the method for preparing a positive electrode composite material, the method further comprises: crushing a calcined product obtained in the step S2 to obtain a crushed product, and then sieving the crushed product by preferably using an about 150 to about 350 mesh sieve.

According to still another aspect of the present invention, provided is a positive electrode of a lithium ion secondary battery, the positive electrode of a lithium ion secondary battery containing the positive electrode composite material as described above.

According to still another aspect of the present invention, provided is a lithium ion secondary battery, the lithium ion secondary battery comprising: a positive electrode, a negative electrode, and a separator, the positive electrode containing the positive electrode composite material as described above.

By the positive electrode composite material, the method for preparing the positive electrode composite material, and the positive electrode and the lithium ion secondary battery which contain the positive electrode composite material in the present invention, the positive electrode matrix material in the lithium ion secondary battery can be effectively prevented from being corroded by an electrolyte, and more lithium ion channels can be reserved, thereby improving the cycle performance of the lithium ion secondary battery, and reducing the impedance increase of the lithium ion secondary battery while not affecting the capacity and initial impedance of the lithium ion secondary battery.

### BRIEF DESCRIPTION OF THE DRAWINGS

FIG. 1 shows a schematic diagram of formation of MgF₂ in a calcination process of step S2.

FIG. 2 shows a schematic diagram in which a fluoride is present on the surface of a positive electrode matrix material in a dotted form.

FIG. 3 shows a scanning electron micrograph of a positive electrode composite material prepared in Example 1.

FIG. 4 shows an XPS analysis result diagram of a positive electrode composite material prepared in Example 1.

### DETAILED DESCRIPTION OF THE EMBODIMENTS

It is to be noted that embodiments in the present application and features in the embodiments may be combined with one another without conflicts. Hereinafter, the present invention will be described in detail with reference to embodiments. The following embodiments are merely exemplary, and are not intended to limit the scope of protection of the present invention.

As explained in the Background, regarding the positive electrode material in the prior art, it is difficult to effectively improve the cycle and ameliorate the impedance increase of the lithium ion secondary battery. In view of the problems in the prior art, a typical embodiment of the present invention provides a positive electrode composite material, the positive electrode composite material comprising: a positive electrode matrix material doped with Mg element; and a fluoride present on the surface of the positive electrode matrix material in a dotted form, the fluoride containing MgF₂.

The fluoride has a high energy gap, can maintain stable performance in an electrolyte of a lithium ion secondary battery, and has good ionic conductivity. In addition, the fluoride is present on the surface of the positive electrode matrix material in a dotted half-coating form rather than a complete-coating form, more lithium ion channels can be reserved without significantly changing the capacity and initial impedance of the lithium ion secondary battery; and during charging and discharging of the lithium ion secondary battery, the positive electrode matrix material is protected by the fluoride present on the surface of the positive electrode matrix material in a dotted form, preventing the positive electrode matrix material in the lithium ion secondary battery from being corroded by an electrolyte, thereby exhibiting lower impedance increase and good cycle performance.

Since magnesium fluoride MgF₂ is an electrically conductive insulator, using the magnesium fluoride MgF₂ to completely coat the positive electrode matrix material will increase the electron resistivity of the material and prevent intercalation and de-intercalation of lithium ions, which has a negative effect on high-power discharge performance of the lithium ion secondary battery. The fluoride containing MgF₂ is present on the surface of the positive electrode matrix material in a dotted half-coating form, and a sufficient active contact area can be reserved, so that the electron conductivity and ion intercalation channels of the material are not affected, and the effect of balanced performance can be achieved.

The positive electrode composite material of the present invention comprises a positive electrode matrix material doped with Mg element and a fluoride containing MgF₂ present on the surface of the positive electrode matrix material in a dotted form, improving the cycle retention rate and ameliorating the impedance after cycle of the lithium ion secondary battery; the initial resistance of the material does not significantly change; the capacity and efficiency of the lithium ion secondary battery will not be affected; and the content of residual lithium after coating changes very little. Doping Mg element can stabilize a crystal structure and improve the cycle performance and thermal stability. In the present invention, in addition to the effects above, MgF₂ is formed on the surface by using Mg and F, to function to protect the surface.

In the positive electrode composite material of the present invention, by doping Mg element in the positive electrode matrix material and by the fluoride present on the surface of the positive electrode matrix material in a dotted form, the positive electrode matrix material in the lithium ion secondary battery can be effectively prevented from being corroded by an electrolyte, and more lithium ion channels can be reserved, thereby improving the cycle performance of the lithium ion secondary battery, and reducing the impedance increase of the lithium ion secondary battery while not affecting the capacity and initial impedance of the lithium ion secondary battery.

In some embodiments of the present invention, in order to more effectively prevent the positive electrode matrix material in the lithium ion secondary battery from being corroded by an electrolyte, more effectively improve the cycle performance of the lithium ion secondary battery, and more effectively reduce impedance increase of the lithium ion secondary battery, in the positive electrode composite material, the fluoride also contains one or more of LiF, AlF₃, NH₄F, MnF₄, TiF₃, ZrF₄, SrF₃ and MoF₅. Specifically, the fluoride may contain a combination of MgF₂ and one of LiF, AlF₃, NH₄F, MnF₄, TiF₃, ZrF₄, SrF₃ and MoF₅; or the fluoride may contain a combination of MgF₂ and multiple of LiF, AlF₃, NH₄F, MnF₄, TiF₃, ZrF₄, SrF₃ and MoF₅.

In some embodiments of the present invention, in the positive electrode composite material, based on the weight of the positive electrode matrix material, the doping concentration of the Mg element is in the range of about 0.05 wt % to about 4.00 wt %, preferably in the range of about 0.30 wt % to about 1.00 wt %. By controlling the doping concentration of the Mg element within the range above, the cycle performance of the lithium ion secondary battery can be significantly improved, the impedance increase of the lithium ion secondary battery can be significantly reduced, and the stability and safety of the lithium ion secondary battery can be improved without affecting the capacity and initial impedance of the lithium ion secondary battery. If the doping concentration of the Mg element is too small, effects may not be achieved; and if the doping concentration of the Mg element is too high, the capacity may decrease.

Specifically, based on the weight of the positive electrode matrix material, the doping concentration of the Mg element may be in the following range: about 0.05 wt % to about 4.00 wt %, about 0.10 wt % to about 3.80 wt %, about 0.15 wt % to about 3.60 wt %, about 0.20 wt % to about 3.40 wt %, about 0.25 wt % to about 3.20 wt %, about 0.30 wt % to about 3.00 wt %, about 0.35 wt % to about 2.80 wt %, about 0.40 wt % to about 2.60 wt %, about 0.45 wt % to about 2.40 wt %, about 0.50 wt % to about 2.20 wt %, about 0.55 wt % to about 2.00 wt %, about 0.60 wt % to about 1.80 wt %, about 0.65 wt % to about 1.60 wt %, about 0.70 wt % to about 1.40 wt %, about 0.75 wt % to about 1.20 wt %, about 0.80 wt % to about 1.00 wt %, about 0.40 wt % to about 0.90 wt %, about 0.50 wt % to about 0.80 wt % or about 0.60 wt % to about 0.70 wt %.

In some embodiments of the present invention, in the positive electrode composite material, the amount of fluorine element in the positive electrode composite material is in the range of about 0.03 wt % to about 0.60 wt %, preferably in the range of about 0.06 wt % to about 0.30 wt %. By controlling the amount of the fluorine element within the range above, the cycle performance of the lithium ion secondary battery can be significantly improved, the impedance increase of the lithium ion secondary battery can be significantly reduced, and the stability and safety of the lithium ion secondary battery can be improved without affecting the capacity and initial impedance of the lithium ion secondary battery. If the addition amount of the fluorine element is too small, effects may not be achieved; and if the addition amount of the fluorine element is too high, the initial resistance may be increased.

In particular, the amount of the fluorine element in the positive electrode composite material may be in the following range: about 0.03 wt % to about 0.60 wt %, about 0.08 wt % to about 0.55 wt %, about 0.13 wt % to about 0.50 wt %, about 0.18 wt % to about 0.45 wt %, about 0.23 wt % to about 0.40 wt %, about 0.28 wt % to about 0.35 wt %, about 0.06 wt % to about 0.30 wt %, about 0.11 wt % to about 0.25 wt % or about 0.16 wt % to about 0.20 wt %.

The positive electrode matrix material in the present invention can use a conventional positive electrode active material in the art. Preferably, in some embodiments of the present invention, the positive electrode matrix material may be a lithium-containing compound. Examples of such a lithium-containing compound comprise lithium-transition metal composite oxides such as lithium nickelate (LiNiO₂) and the like.

In some embodiments of the present invention, in the positive electrode composite material, the positive electrode matrix material contains a high-nickel positive electrode material of general formula LiNiₓCo_{y}M_{(1-x-y)}O₂, where M is selected from one or two of Al and Mn, x≥0.6, and 0<y<0.4. Preferably, in the positive electrode composite material, the positive electrode matrix material is a high-nickel positive electrode material of the general formula above.

When the positive electrode matrix material contains the high-nickel positive electrode material of the general formula above, by doping Mg element in the positive electrode matrix material containing the high-nickel positive electrode material and by the fluoride present on the surface of the positive electrode matrix material containing the high-nickel positive electrode material in a dotted form, the positive electrode composite material of the present invention can more effectively prevent the positive electrode matrix material containing the high-nickel positive electrode material in the lithium ion secondary battery from being corroded by an electrolyte, and can reserve more lithium ion channels, thereby improving the cycle performance of the lithium ion secondary battery, further reducing the impedance increase of the lithium ion secondary battery while not affecting the capacity and initial impedance of the lithium ion secondary battery, and solving the problem of increase of the initial impedance caused by coating a positive electrode matrix material containing a high-nickel positive electrode material, and solving the problem of an excessively high increase of impedance after cycle when the positive electrode matrix material containing the high-nickel positive electrode material is used as a positive electrode material of a lithium ion battery.

In some embodiments of the present invention, in the positive electrode composite material, the Mg element is distributed in a gradient manner within particles of the positive electrode matrix material, and the concentration of the Mg element gradually decreases from the inside of the particles toward the outside of the particles. The presence of the Mg element on the surface of the positive electrode matrix material will increase the initial impedance, but the gradient distribution of the concentration can make a small amount of Mg present on the surface of the positive electrode matrix material in the form of MgF₂, so as to not affect the initial impedance to the maximum extent.

In another typical embodiment of the present invention, provided is a method for preparing a positive electrode composite material, the method comprising: step S1: mixing a positive electrode material precursor, lithium hydroxide and magnesium oxide to obtain a first mixture, and then sintering the first mixture at a first temperature for a first time to obtain a sintered product; and step S2: mixing fluoride with the sintered product to obtain a second mixture, and then calcining the second mixture at a second temperature for a second time.

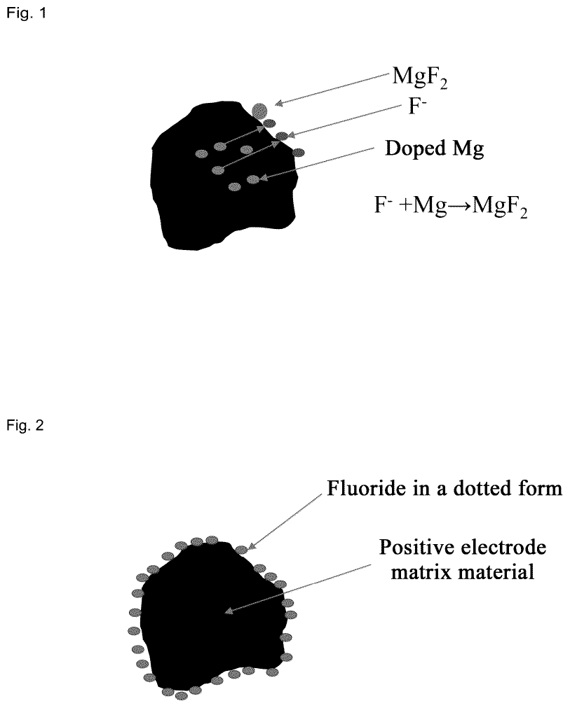

In the method for preparing a positive electrode composite material of the present invention, in step S1, a sintering process is performed to dope Mg in the positive electrode matrix material, and in step S2, a calcining process is performed to dry-coat fluoride on the surface of the positive electrode matrix material, such that the fluoride reacts with Mg doped in the positive electrode matrix material to generate MgF₂, so as to form fluoride containing MgF₂ present on the surface of the positive electrode matrix material in a dotted form, thereby solving the problems of the positive electrode material in the prior art that it is difficult to effectively improve the cycle and ameliorate the impedance increase of the lithium ion secondary battery. FIG. 1 shows a schematic diagram of formation of MgF₂ in a calcination process of step S2. FIG. 2 shows a schematic diagram in which a fluoride is present on the surface of a positive electrode matrix material in a dotted form.

The key technical points of the present invention lie in that Mg doped in the calcining process reacts with the fluoride to generate MgF₂, and the fluoride is present on the surface of the positive electrode matrix material in a dotted half-coating form, which does not significantly increase the initial impedance of the lithium ion secondary battery; and the fluoride, especially a metal fluoride, has an extremely high energy gap, and is not easy to react with the electrolyte in the lithium ion secondary battery, thereby protecting the positive electrode matrix material.

Furthermore, in the method for preparing a positive electrode composite material of the present invention, a dry method is used to perform dotted half-coating on the positive electrode matrix material, the overall preparation process is simple, and the coating temperature is low, thereby achieving high economy.

In the positive electrode composite material prepared by the method of the present invention, the fluoride has a high energy gap, can maintain stable performance in the electrolyte of the lithium ion secondary battery, and has good ionic conductivity. In addition, the fluoride is present on the surface of the positive electrode matrix material in a dotted half-coating form rather than a complete-coating form, more lithium ion channels can be reserved without significantly changing the capacity and initial impedance of the lithium ion secondary battery; and during charging and discharging of the lithium ion secondary battery, the positive electrode matrix material is protected by the fluoride present on the surface of the positive electrode matrix material in a dotted form, preventing the positive electrode matrix material in the lithium ion secondary battery from being corroded by an electrolyte, thereby exhibiting lower impedance increase and good cycle performance.

In the positive electrode composite material prepared by the method of the present invention, by doping Mg element in the positive electrode matrix material and by the fluoride present on the surface of the positive electrode matrix material in a dotted form, the positive electrode matrix material in the lithium ion secondary battery can be effectively prevented from being corroded by an electrolyte, and more lithium ion channels can be reserved, thereby improving the cycle performance of the lithium ion secondary battery, and reducing the impedance increase of the lithium ion secondary battery while not affecting the capacity and initial impedance of the lithium ion secondary battery.

In some embodiments of the present invention, in the method for preparing a positive electrode composite material, in step S1, the first temperature is within a range of about 650° C. to about 780° C., and the first time is within a range of about 6 h to about 24 h; preferably, the first temperature is within a range of about 660° C. to about 760° C., and the first time is in a range of about 7 h to about 20 h; more preferably, the first temperature is within a range of about 670° C. to about 740° C., and the first time is within a range of about 8 h to about 16 h; and most preferably, the first temperature is within a range of about 680° C. to about 720° C., and the first time is within a range of about 8 h to about 12 h. By controlling the first temperature and the first time in step S1 to be within the described ranges, Mg element can be well doped in the positive electrode matrix material to obtain a good Mg doping effect, the cycle performance of the lithium ion secondary battery can be improved, and increase of the impedance of the lithium ion secondary battery can be reduced.

In some embodiments of the present invention, in the method for preparing a positive electrode composite material, in step S2, the second temperature is within a range of about 200° C. to about 350° C., and the second time is within a range of about 2 h to about 8 h; preferably, the second temperature is within a range of about 250° C. to about 340° C., and the second time is within a range of about 3 h to about 7 h; more preferably, the second temperature is within a range of about 270° C. to about 320° C., and the second time is within a range of about 4 h to about 6 h; further preferably, the second temperature is within a range of about 280° C. to about 310° C., and the second time is within a range of about 4 h to about 5 h; and most preferably, the second temperature is within a range of about 290° C. to about 300° C., and the second time is within a range of about 4 h to about 5 h. By controlling the second temperature and the second time in step S2 to be within the described ranges, the fluoride can well react with Mg doped in the positive electrode matrix material to generate MgF₂, so as to obtain a good dotted half-coating effect, the cycle performance of the lithium ion secondary battery can be improved, and increase of the impedance of the lithium ion secondary battery can be reduced.

In some embodiments of the present invention, in order to more effectively prevent the positive electrode matrix material in the lithium ion secondary battery from being corroded by an electrolyte, more effectively improve the cycle performance of the lithium ion secondary battery, and more effectively reduce impedance increase of the lithium ion secondary battery, in the method for preparing a positive electrode composite material, the fluoride contains one or more of MgF₂, LiF, AlF₃, NH₄F, MnF₄, TiF₃, ZrF₄, SrF₃ and MoF₅. When the fluoride added in the step S2 contains one or more of LiF, AlF₃, NH₄F, MnF₄, TiF₃, ZrF₄, SrF₃ and MoF₅, the fluoride in the step S2 undergoes a replacement reaction with Mg doped in the positive electrode matrix material to generate MgF₂; and thus the finally obtained positive electrode composite material comprises a combination of MgF₂ and one or more of LiF, AlF₃, NH₄F, MnF₄, TiF₃, ZrF₄, SrF₃ and MoF₅ present on the surface of the positive electrode matrix material in a dotted form.

In some embodiments of the present invention, in the method for preparing a positive electrode composite material, based on the weight of the positive electrode material precursor, the amount of the magnesium oxide is in the range of about 0.10 wt % to about 5.00 wt %, preferably in the range of about 0.50 wt % to about 1.50 wt %. By controlling the amount of the magnesium oxide added in the step S1 within the range above, the cycle performance of the lithium ion secondary battery can be significantly improved, the impedance increase of the lithium ion secondary battery can be significantly reduced, and the stability and safety of the lithium ion secondary battery can be improved without affecting the capacity and initial impedance of the lithium ion secondary battery.

Specifically, based on the weight of the positive electrode material precursor, the amount of the magnesium oxide may be in the following ranges: about 0.10 wt % to about 5.00 wt %, about 0.15 wt % to about 4.80 wt %, about 0.20 wt % to about 4.60 wt %, about 0.25 wt % to about 4.40 wt %, about 0.30 wt % to about 4.20 wt %, about 0.35 wt % to about 4.00 wt %, about 0.40 wt % to about 3.80 wt %, about 0.45 wt % to about 3.60 wt %, about 0.50 wt % to about 3.40 wt %, about 0.55 wt % to about 3.20 wt %, about 0.60 wt % to about 3.00 wt %, about 0.65 wt % to about 2.80 wt %, about 0.70 wt % to about 2.60 wt %, about 0.75 wt % to about 2.40 wt %, about 0.80 wt % to about 2.20 wt %, about 0.85 wt % to about 2.00 wt %, about 0.90 wt % to about 1.80 wt %, about 0.95 wt % to about 1.60 wt %, about 1.00 wt % to about 1.40 wt %, about 1.05 wt % to about 1.20 wt %, about 1.10 wt % to about 1.30 wt %, about 0.50 wt % to about 1.50 wt %, about 0.50 wt % to about 1.40 wt %, about 0.50 wt % to about 1.30 wt %, about 0.50 wt % to about 1.20 wt %, about 0.50 wt % to about 1.10 wt %, about 0.50 wt % to about 1.00 wt %, about 0.50 wt % to about 0.90 wt %, about 0.50 wt % to about 0.80 wt %, about 0.50 wt % to about 0.70 wt % or about 0.50 wt % to about 0.60 wt %.

In some embodiments of the present invention, in the method for preparing a positive electrode composite material, based on the weight of the positive electrode material precursor, the amount of the fluoride is in the range of about 0.05 wt % to about 1.00 wt %, preferably in the range of about 0.10 wt % to about 0.50 wt %. By controlling the amount of the fluoride added in the step S2 within the range above, the cycle performance of the lithium ion secondary battery can be significantly improved, the impedance increase of the lithium ion secondary battery can be significantly reduced, and the stability and safety of the lithium ion secondary battery can be improved without affecting the capacity and initial impedance of the lithium ion secondary battery.

Specifically, based on the weight of the positive electrode material precursor, the amount of the fluoride may be in the following ranges: about 0.05 wt % to about 1.00 wt %, about 0.10 wt % to about 0.90 wt %, about 0.15 wt % to about 0.80 wt %, about 0.20 wt % to about 0.70 wt %, about 0.25 wt % to about 0.60 wt %, about 0.30 wt % to about 0.50 wt %, about 0.35 wt % to about 0.40 wt %, about 0.10 wt % to about 0.50 wt %, about 0.10 wt % to about 0.45 wt %, about 0.15 wt % to about 0.40 wt %, about 0.20 wt % to about 0.35 wt % or about 0.25 wt % to about 0.30 wt %.

In some embodiments of the present invention, in the method for preparing a positive electrode composite material, the sintering or the calcining is performed in an air atmosphere or an oxygen atmosphere. Specifically, the first mixture is sintered in an air atmosphere or an oxygen atmosphere; or the second mixture is calcined in an air atmosphere or an oxygen atmosphere. The second mixture may be calcined in a calcinator or a continuous furnace. If the positive electrode matrix material contains a high-nickel positive electrode material, the sintering is preferably performed in a pure oxygen atmosphere for preparation, otherwise the crystal structure may have a defect. If oxygen is not contained in the sintering atmosphere when preparing the positive electrode composite material, a defect in the crystal structure of the positive electrode matrix material easily occurs. However, since the sintering temperature is low when preparing the positive electrode composite material, a pure oxygen atmosphere is not necessarily required, but an oxygen atmosphere or an air atmosphere is also required.

In some embodiments of the present invention, in the method for preparing a positive electrode composite material, in the step S2, mixing of the fluoride and the sintered product can be carried out in a ball mill or a high-speed dry mixer. In some embodiments of the present invention, in the step S2, mixing of the fluoride and the sintered product is carried out in a ball mill for about 10 min to about 60 min, and the rotational speed of the ball mill is in the range of about 250 r/min to about 300 r/min. The ball mill contains agate balls having different particle sizes therein, such that materials can be mixed sufficiently. By controlling the mixing time and the rotational speed of the ball mill in the step S2 to be within the described ranges, it can be ensured that the fluoride and the sintered product are sufficiently and uniformly mixed.

In some embodiments of the present invention, in the method for preparing a positive electrode composite material, conventional positive electrode material precursors in the art can be used. Preferably, the positive electrode material precursor contains a material of general formula NiₓCo_{y}Mn_{(1-x-y)}(OH)₂ or NiₓCo_{y}Al_{(1-x-y)}(OH)_{(3-x-y)}, where 0.8≤x<1 and 0.01≤y<0.2. When the positive electrode material precursor contains a material of the general formula above, a positive electrode composite material comprising a positive electrode matrix material containing a high-nickel positive electrode material can be obtained. The positive electrode composite material of the present invention can more effectively prevent the positive electrode matrix material containing the high-nickel positive electrode material in the lithium ion secondary battery from being corroded by an electrolyte, and can reserve more lithium ion channels, thereby significantly improving the cycle performance of the lithium ion secondary battery, further reducing the impedance increase of the lithium ion secondary battery while not affecting the capacity and initial impedance of the lithium ion secondary battery, and solving the problem of increase of the initial impedance caused by coating a positive electrode matrix material containing a high-nickel positive electrode material, and solving the problem of an excessively high increase of impedance after cycle when the positive electrode matrix material containing the high-nickel positive electrode material is used as a positive electrode material of a lithium ion battery.

In some embodiments of the present invention, in the method for preparing a positive electrode composite material, the method further comprises: crushing a calcined product obtained in the step S2 to obtain a crushed product, and then sieving the crushed product by preferably using an about 150 to about 350 mesh sieve. The presence of large particles will affect subsequent preparation and coating of a positive electrode slurry, and preparation of electrode sheets. The large particles can be removed by sieving. By the described steps, a positive electrode composite material having an appropriate granularity can be obtained.

In still another typical embodiment of the present invention, provided is a positive electrode of a lithium ion secondary battery, the positive electrode of a lithium ion secondary battery containing the positive electrode composite material as described above. As the positive electrode of a lithium ion secondary battery of the present invention contains the positive electrode composite material as described above, the positive electrode matrix material in the lithium ion secondary battery can be effectively prevented from being corroded by an electrolyte, and more lithium ion channels can be reserved, thereby improving the cycle performance of the lithium ion secondary battery, reducing the impedance increase of the lithium ion secondary battery while not affecting the capacity and initial impedance of the lithium ion secondary battery.

In still another typical embodiment of the present invention, provided is a lithium ion secondary battery, the lithium ion secondary battery comprising: a positive electrode, a negative electrode, and a separator, the positive electrode containing the positive electrode composite material as described above. As the lithium ion secondary battery of the present invention contains the positive electrode composite material as described above, the positive electrode matrix material in the lithium ion secondary battery can be effectively prevented from being corroded by an electrolyte, and more lithium ion channels can be reserved, thereby improving the cycle performance of the lithium ion secondary battery, reducing the impedance increase of the lithium ion secondary battery while not affecting the capacity and initial impedance of the lithium ion secondary battery.

The positive electrode of the present invention comprises a positive electrode current collector and a positive electrode active material layer containing the positive electrode composite material. The positive electrode active material layer is formed on both surfaces of the positive electrode current collector. A metal foil such as an aluminum foil, a nickel foil, or a stainless steel foil may be used as the positive electrode current collector.

The negative electrode of the present invention comprises a negative electrode current collector and a negative electrode active material layer containing a negative electrode active material. The negative electrode active material layer is formed on both surfaces of the negative electrode current collector. A metal foil such as a copper (Cu) foil, a nickel foil, or a stainless steel foil may be used as the negative electrode current collector.

The negative electrode active material layer contains, as a negative electrode active material, one or more negative electrode materials capable of intercalating and de-intercalating lithium ions, and may contain, as necessary, another material, for example, a negative electrode binder and/or a negative electrode conductive agent. The negative electrode active material may be selected from one or more of lithium metal, a lithium alloy, a carbon material, silicon or tin, and oxides thereof.

The separator of the present invention is used to separate the positive electrode and the negative electrode in the battery, and allow lithium ions to pass therethrough, while preventing current short-circuiting due to contact between the positive electrode and the negative electrode. The separator is, for example, a porous membrane formed of a synthetic resin or ceramic, and may be a laminated membrane in which two or more porous membranes are laminated. Examples of the synthetic resin comprise polytetrafluoroethylene, polypropylene, polyethylene, and the like.

In embodiments of the present invention, when the lithium ion secondary battery is charged, for example, lithium ions are de-intercalated from the positive electrode and are intercalated into the negative electrode through the electrolyte impregnated in the separator. When the lithium ion secondary battery is discharged, for example, lithium ions are de-intercalated from the negative electrode and are intercalated into the positive electrode through the electrolyte impregnated in the separator.

Hereinafter, the present application will be further described in detail in combination with specific examples, and these examples cannot be understood as limiting the scope of protection of the present application.

### Example 1

Step S1: weighing 100 g of a positive electrode material precursor Ni_{0.8}Co_{0.1}Mn_{0.1}(OH)₂, 27 g of LiOH and 0.5 g of magnesium oxide, uniformly mixing the positive electrode material precursor, LiOH and magnesium oxide, and sintering same at 680° C. for 8 h in a pure oxygen atmosphere, so as to obtain a sintered product doped with Mg;

step S2: weighing 0.3 g of MgF₂ as a coating material, and adding the coating material and the sintered product obtained by sintering in step S1 to a mixer for uniform mixing, wherein the rotational speed of the mixer is 300 r/min, and the mixing time is 30 min; placing the mixed material in a calcinator, introducing oxygen and calcining same at a temperature of 300° C. for 4 h, taking out the calcined product, crushing the product by using a crusher and then sieving same by using a 200 mesh sieve, thereby obtaining a positive electrode composite material; and

step S3: weighing 90 g of the positive electrode composite material prepared by the process above, 5 g of conductive carbon black as a conductive agent and 5 g of polyvinylidene fluoride (PVDF) as a binder, to prepare an electrode sheet, and preparing a half-cell by using the electrode sheet above, and the results are shown in Table 1.

### Example 2

A half-cell was prepared by using the same method as that in Example 1, and the difference lies in that: in step S1, 100 g of a positive electrode material precursor Ni_{0.8}Co_{0.1}Mn_{0.1}(OH)₂ was replaced with 100 g of a positive electrode material precursor Ni_{0.8}Co_{0.15}Al_{0.05}(OH)₂.

### Example 3

A half-cell was prepared by using the same method as that in Example 1, and the difference lies in that: in step S2, 0.3 g of MgF₂ as a coating material was replaced with 0.3 g of LiF as a coating material.

### Example 4

A half-cell was prepared by using the same method as that in Example 1, and the difference lies in that: in step S2, 0.3 g of MgF₂ as a coating material was replaced with 0.3 g of AlF₃ as a coating material.

### Example 5

A half-cell was prepared by using the same method as that in Example 1, and the difference lies in that: in step S2, 0.3 g of MgF₂ as a coating material was replaced with 0.3 g of TiF₃ as a coating material.

### Example 6

A half-cell was prepared by using the same method as that in Example 1, and the difference lies in that: in step S2, 0.3 g of MgF₂ as a coating material was replaced with 0.3 g of ZrF₄ as a coating material.

### Example 7

A half-cell was prepared by using the same method as that in Example 1, and the difference lies in that: in step S2, 0.3 g of MgF₂ as a coating material was replaced with 0.3 g of SrF₃ as a coating material.

### Example 8

A half-cell was prepared by using the same method as that in Example 1, and the difference lies in that: in step S2, 0.3 g of MgF₂ as a coating material was replaced with 0.3 g of MoF₅ as a coating material.

### Example 9

A half-cell was prepared by using the same method as that in Example 1, and the difference lies in that: in step S2, 0.3 g of MgF₂ as a coating material was replaced with 0.3 g of NH₄F as a coating material.

### Example 10

A half-cell was prepared by using the same method as that in Example 1, and the difference lies in that: in step S2, 0.3 g of MgF₂ as a coating material was replaced with 0.3 g of MnF₄ as a coating material.

### Example 11

A half-cell was prepared by using the same method as that in Example 1, and the difference lies in that: in step S2, calcining at a temperature of 300° C. for 4 h was replaced with calcining at a temperature of 250° C. for 4 h.

### Example 12

A half-cell was prepared by using the same method as that in Example 1, and the difference lies in that: in step S2, calcining at a temperature of 300° C. for 4 h was replaced with calcining at a temperature of 350° C. for 4 h.

### Example 13

A half-cell was prepared by using the same method as that in Example 1, and the difference lies in that: in step S2, 0.3 g of MgF₂ as a coating material was replaced with 0.05 g of MgF₂ as a coating material.

### Example 14

A half-cell was prepared by using the same method as that in Example 1, and the difference lies in that: in step S2, 0.3 g of MgF₂ as a coating material was replaced with 1.0 g of MgF₂ as a coating material.

### Example 15

A half-cell was prepared by using the same method as that in Example 1, and the difference lies in that: in step S1, 0.5 g of magnesium oxide was replaced with 0.1 g of magnesium oxide.

### Example 16

A half-cell was prepared by using the same method as that in Example 1, and the difference lies in that: in step S1, 0.5 g of magnesium oxide was replaced with 1.5 g of magnesium oxide.

### Example 17

A half-cell was prepared by using the same method as that in Example 1, and the difference lies in that: in step S1, 0.5 g of magnesium oxide was replaced with 5.0 g of magnesium oxide.

### Example 18

A half-cell was prepared by using the same method as that in Example 1, and the difference lies in that: in step S1, sintering at 680° C. for 8 h was replaced with sintering at 650° C. for 6 h.

### Example 19

A half-cell was prepared by using the same method as that in Example 1, and the difference lies in that: in step S1, sintering at 680° C. for 8 h was replaced with sintering at 780° C. for 24 h.

### Comparative Example 1

weighing 100 g of a positive electrode material precursor Ni_{0.8}Co_{0.1}Mn_{0.1}(OH)₂, 27 g of LiOH and 0.5 g of magnesium oxide, uniformly mixing the positive electrode material precursor, LiOH and magnesium oxide, and sintering same at 680° C. for 8 h in a pure oxygen atmosphere, so as to obtain a positive electrode material doped with Mg; and weighing 90 g of the positive electrode material prepared by the process above, 5 g of conductive carbon black as a conductive agent and 5 g of polyvinylidene fluoride (PVDF) as a binder, to prepare an electrode sheet, and preparing a half-cell by using the electrode sheet above, and the results are shown in Table 1.

### Comparative Example 2

A half-cell was prepared by using the same method as that in Example 1, and the difference lies in that: in step S1, sintering at 680° C. for 8 h was replaced with sintering at 800° C. for 8 h.

### Comparative Example 3

Step S1: weighing 100 g of a positive electrode material precursor Ni_{0.8}Co_{0.1}Mn_{0.1}(OH)₂ and 27 g of LiOH, uniformly mixing the positive electrode material precursor and LiOH, and sintering same at 680° C. for 8 h in a pure oxygen atmosphere, so as to obtain a sintered product;

step S2: weighing 0.3 g of MgF₂ as a coating material, and adding the coating material and the sintered product obtained by sintering in step S1 to a mixer for uniform mixing, wherein the rotational speed of the mixer is 300 r/min, and the mixing time is 30 min; placing the mixed material in a calcinator, introducing oxygen and calcining same at a temperature of 300° C. for 4 h, taking out the calcined product, crushing the product by using a crusher and then sieving same by using a 200 mesh sieve, thereby obtaining a positive electrode composite material; and

step S3: weighing 90 g of the positive electrode composite material prepared by the process above, 5 g of conductive carbon black as a conductive agent and 5 g of polyvinylidene fluoride (PVDF) as a binder, to prepare an electrode sheet, and preparing a half-cell by using the electrode sheet above, and the results are shown in Table 1.

### Comparative Example 4

Step S1: weighing 100 g of a positive electrode material precursor Ni_{0.8}Co_{0.1}Mn_{0.1}(OH)₂, 27 g of LiOH and 0.5 g of magnesium oxide, uniformly mixing the positive electrode material precursor, LiOH and magnesium oxide, and sintering same at 680° C. for 8 h in a pure oxygen atmosphere, so as to obtain a sintered product doped with Mg;

step S2: weighing 0.3 g of MgF₂ as a coating material, dissolving the coating material in 30 ml of water, and adding the prepared aqueous solution and the sintered product obtained by sintering in step S1 to a mixer for uniform mixing, wherein the rotational speed of the mixer is 300 r/min, and the mixing time is 30 min; after filtering and drying, placing the mixed material in a calcinator, introducing oxygen and calcining same at a temperature of 300° C. for 4 h, taking out the calcined product, crushing the product by using a crusher and then sieving same by using a 200 mesh sieve, thereby obtaining a positive electrode composite material; and

step S3: weighing 90 g of the positive electrode composite material prepared by the process above, 5 g of conductive carbon black as a conductive agent and 5 g of polyvinylidene fluoride (PVDF) as a binder, to prepare an electrode sheet, and preparing a half-cell by using the electrode sheet above, and the results are shown in Table 1.

### Test of Battery Performance

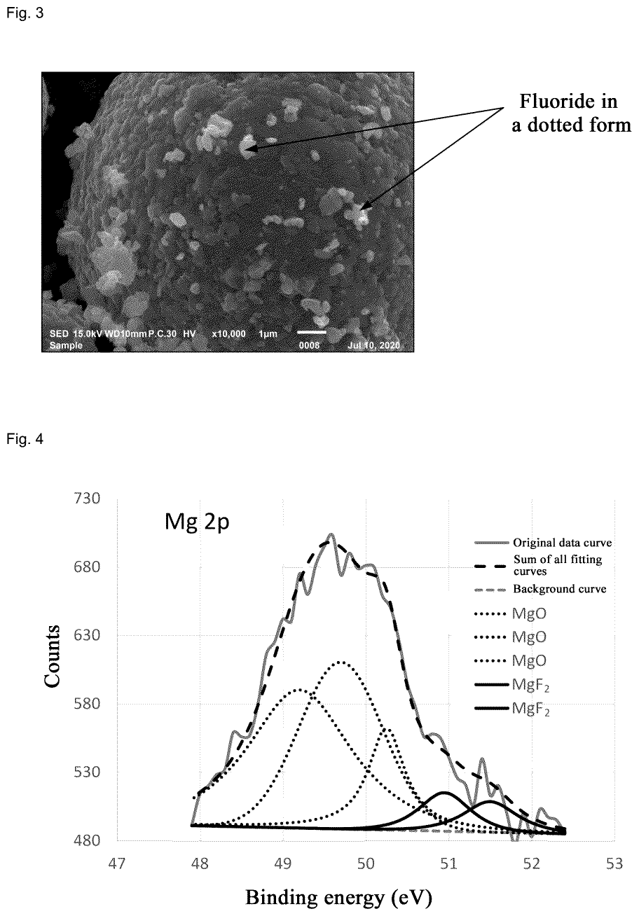

The half-cells of Examples 1-19 and Comparative Examples 1˜4 were subjected to a charge and discharge test and an impedance test at a voltage of 2.0 V to 4.25 V. The half-cells in the Examples and Comparative Examples were first subjected to one charge and discharge test of 0.1 C at 23° C. to determine the initial discharge capacity and initial impedance of the cell, and then subjected to a cycle test of 1 C charging and 5 C discharging at 60° C. for 100 times to determine the capacity retention rate and the after-cycle impedance increase factor after 100 cycles of the cell. The experimental results are shown in Table 1 below and FIGS. 3-4. FIG. 4 specifically shows a spectrum of 2p electron orbitals of Mg element, in which a MgF₂ fitting curve and a MgO fitting curve can be clearly seen from FIG. 4, and a background curve needs to be deducted before fitting.

TABLE 1
Electrochemical performance test results

| | Initial | | | Capacity |
|---|---|---|---|---|
| | discharge | Initial | Impedance | retention |
| Experiment | capacity | impedance | increase | rate after |
| No. | (mAh/g) | (Ω) | factor | 100 cycles (%) |
| Example 1 | 192 | 4.2 | 5.0 | 90 |
| Example 2 | 190 | 4.3 | 5.2 | 91 |
| Example 3 | 191 | 4.3 | 5.0 | 91 |
| Example 4 | 191 | 4.2 | 5.4 | 90 |
| Example 5 | 191 | 4.2 | 4.9 | 89 |
| Example 6 | 192 | 4.4 | 5.2 | 91 |
| Example 7 | 191 | 4.3 | 5.0 | 92 |
| Example 8 | 190 | 4.2 | 5.3 | 90 |
| Example 9 | 191 | 4.2 | 5.0 | 91 |
| Example 10 | 190 | 4.2 | 5.1 | 90 |
| Example 11 | 190 | 4.7 | 5.9 | 86 |
| Example 12 | 192 | 4.4 | 5.0 | 88 |
| Example 13 | 192 | 4.2 | 5.8 | 85 |
| Example 14 | 192 | 4.4 | 5.3 | 89 |
| Example 15 | 192 | 3.6 | 5.5 | 86 |
| Example 16 | 190 | 4.8 | 4.8 | 91 |
| Example 17 | 189 | 4.9 | 5.2 | 88 |
| Example 18 | 189 | 4.5 | 4.8 | 90 |
| Example 19 | 192 | 4.0 | 6.0 | 86 |
| Comparative | 192 | 3.8 | 10.0 | 75 |
| Example 1 | | | | |
| Comparative | 192 | 4.2 | 8.0 | 70 |
| Example 2 | | | | |
| Comparative | 192 | 4.2 | 6.3 | 74 |
| Example 3 | | | | |
| Comparative | 189 | 7.0 | 10.0 | 79 |
| Example 4 | | | | |

It can be seen from the test results that the examples above of the present invention achieve the following technical effects:

by comparing the results of Examples 1-19 with those of Comparative Example 1, it can be seen that compared with Comparative Example 1 in which fluoride was not present on the surface of the positive electrode matrix material, the cells of Examples 1-19 in which the fluoride in a dotted form was present on the surface of the positive electrode matrix material has a lower impedance increase factor and a significantly higher capacity retention rate after 100 cycles. In particular, by comparing Examples 1 and 3-14 with Comparative Example 1 in which the conditions of step S1 are completely the same, it can be seen that compared with Comparative Example 1 in which fluoride was not present on the surface of the positive electrode matrix material, the cells of Examples 1 and 3-14 in which the fluoride in a dotted form was present on the surface of the positive electrode matrix material has a lower impedance increase factor and a significantly higher capacity retention rate after 100 cycles. In addition, due to coating, it is reasonable that the initial impedance in some Examples is slightly higher than the initial impedance in the Comparative Examples.

By comparing the results of Example 1 with those of Comparative Example 2, it can be seen that compared with Comparative Example 2 in which the sintering temperature in step S1 is higher, the cell of Example 1 of the present invention has a significantly lower impedance increase factor and a significantly higher capacity retention rate after 100 cycles without any change in the initial discharge capacity and initial impedance of the cell.

By comparing the results of Examples 1-19 with those of Comparative Example 3, it can be seen that compared with Comparative Example 3 in which Mg element was not doped in the positive electrode matrix material, the cells of Examples 1-19 in which the Mg element was doped in the positive electrode matrix material has a lower impedance increase factor and a significantly higher capacity retention rate after 100 cycles.

By comparing the results of Example 1 with those of Comparative Example 4, it can be seen that compared with Comparative Example 4 in which wet complete-coating was carried out, the cell of Example 1 in which dry dotted half-coating was carried out of the present invention has a significantly lower impedance increase factor, a significantly higher capacity retention rate after 100 cycles, higher initial discharge capacity and lower initial impedance.

By comparing the results of Examples 1 and 16 with those of Examples 15 and 17, it can be seen that when the amount of magnesium oxide is within a range of about 0.50 wt % to about 1.50 wt % based on the weight of the positive electrode material precursor, the impedance increase factor can be further reduced and the capacity retention rate after 100 cycles can be further increased.

By comparing the results of Example 1 with those of Examples 13-14, it can be seen that when the amount of fluoride is in a range of about 0.10 wt % to about 0.50 wt % based on the weight of the positive electrode material precursor, better effects can be achieved in terms of reducing the impedance increase factor and increasing the capacity retention rate after 100 cycles.

It can be determined from the described battery performance test results: by the positive electrode composite material, the method for preparing the positive electrode composite material, and the positive electrode and the lithium ion secondary battery which contain the positive electrode composite material in the present invention, the positive electrode matrix material in the lithium ion secondary battery can be effectively prevented from being corroded by an electrolyte, and more lithium ion channels can be reserved, thereby improving the cycle performance of the lithium ion secondary battery, and reducing the impedance increase of the lithium ion secondary battery while not affecting the capacity and initial impedance of the lithium ion secondary battery.

The content as described above is only preferred embodiments of the present invention and is not intended to limit the present invention. For a person skilled in the art, the present invention may have various modifications and variations. Any modifications, equivalent replacements, improvements, etc. made within the spirit and principle of the present invention shall all fall within the scope of protection of the present invention.

1. A positive electrode composite material, wherein the positive electrode composite material comprises:
a positive electrode matrix material doped with Mg element; and
a fluoride present on the surface of the positive electrode matrix material in a dotted form, the fluoride containing MgF₂.

2. The positive electrode composite material according to claim 1, wherein the fluoride also contains one or more of LiF, AlF₃, NH₄F, MnF₄, TiF₃, ZrF₄, SrF₃ and MoF₅.

3. The positive electrode composite material according to claim 1, wherein based on the weight of the positive electrode matrix material, the doping concentration of the Mg element is in the range of about 0.05 wt % to about 4.00 wt %, preferably in the range of about 0.30 wt % to about 1.00 wt %.

4. The positive electrode composite material according to claim 1, wherein the amount of fluorine element in the positive electrode composite material is in the range of about 0.03 wt % to about 0.60 wt %, preferably in the range of about 0.06 wt % to about 0.30 wt %.

5. The positive electrode composite material according to claim 1, wherein the positive electrode matrix material contains a high-nickel positive electrode material of general formula LiNiₓCo_{y}M_{(1-x-y)}O₂, where M is selected from one or two of Al and Mn, x≥0.6, and 0<y<0.4.

6. The positive electrode composite material according to claim 1, wherein the Mg element is distributed in a gradient manner within particles of the positive electrode matrix material, and the concentration of the Mg element gradually decreases from the inside of the particles toward the outside of the particles.

7. A method for preparing a positive electrode composite material, wherein the method comprises:
step S1: mixing a positive electrode material precursor, lithium hydroxide and magnesium oxide to obtain a first mixture, and then sintering the first mixture at a first temperature for a first time to obtain a sintered product; and
step S2: mixing fluoride with the sintered product to obtain a second mixture, and then calcining the second mixture at a second temperature for a second time.

8. The method for preparing a positive electrode composite material according to claim 7, wherein in the step S1, the first temperature is within a range of about 650° C. to about 780° C., and the first time is within a range of about 6 h to about 24 h.

9. The method for preparing a positive electrode composite material according to claim 7, wherein in the step S2, the second temperature is within a range of about 200° C. to about 350° C., and the second time is within a range of about 2 h to about 8 h.

10. The method for preparing a positive electrode composite material according to claim 7, wherein the fluoride contains one or more of MgF₂, LiF, AlF₃, NH₄F, MnF₄, TiF₃, ZrF₄, SrF₃ and MoF₅.

11. The method for preparing a positive electrode composite material according to claim 7, wherein based on the weight of the positive electrode material precursor, the amount of the magnesium oxide is in the range of about 0.10 wt % to about 5.00 wt %, preferably in the range of about 0.50 wt % to about 1.50 wt %.

12. The method for preparing a positive electrode composite material according to claim 7, wherein based on the weight of the positive electrode material precursor, the amount of the fluoride is in the range of about 0.05 wt % to about 1.00 wt %, preferably in the range of about 0.10 wt % to about 0.50 wt %.

13. The method for preparing a positive electrode composite material according to claim 7, wherein the sintering or the calcining is performed in an air atmosphere or an oxygen atmosphere.

14. The method for preparing a positive electrode composite material according to claim 7, wherein in the step S2, mixing of the fluoride and the sintered product is carried out in a ball mill for about 10 min to about 60 min, and the rotational speed of the ball mill is in the range of about 250 r/min to about 300 r/min.

15. The method for preparing a positive electrode composite material according to claim 7, wherein the positive electrode material precursor contains a material of general formula NiₓCo_{y}Mn_{(1-x-y)}(OH)₂ or NiₓCo_{y}Al_{(1-x-y)}(OH)_{(3-x-y)}, where 0.8≤x<1 and 0.01≤y<0.2.

16. The method for preparing a positive electrode composite material according to claim 7, wherein the method further comprises: crushing a calcined product obtained in the step S2 to obtain a crushed product, and then sieving the crushed product by preferably using an about 150 to about 350 mesh sieve.

17. A lithium ion secondary battery, wherein the lithium ion secondary battery comprises:
a positive electrode,
a negative electrode, and
a separator,
wherein the positive electrode comprises the positive electrode composite material according to claim 1.
